(19) United States
(12) Patent Application Publication
(10) Pub. No.: US 2020/0381848 A1
(43) Pub. Date: Dec. 3, 2020

(54) EARTH GROUND ENHANCING SYSTEMS

(71) Applicant: Mat Ipsum LLC, Corpus Christi, TX (US)

(72) Inventor: Charles Mitchell Stilwell, Owasso, OK (US)

(21) Appl. No.: 16/888,386

(22) Filed: May 29, 2020

Related U.S. Application Data
(60) Provisional application No. 62/855,318, filed on May 31, 2019.

(51) Int. Cl. H01R 4/66; H01R 4/62

(52) U.S. Cl. CPC H01R 4/66; H01R 4/62

(57) ABSTRACT

The present disclosure provides earth ground enhancing systems that improve the dissipation of electrical energy, e.g., static electrical charges, that may build up on a grounded structure or a group of grounded structures. The earth ground enhancing systems include one or more conductors and one or more conductive mats attached to the one or more conductors. The present disclosure also provides methods for assembling or installing such earth ground enhancing systems, methods for grounding a structure or a group of structures. The present disclosure also provides embodiments of kits for the distribution of components forming the earth ground enhancing systems.

### CROSS REFERENCE TO RELATED APPLICATIONS

The present disclosure is based on and claims benefit from co-pending U.S. Provisional Patent Application Ser. No. 62/855,318, filed May 31, 2019 entitled “Earth Ground Enhancing Systems” the entire contents of which are incorporated herein by reference.

### BACKGROUND

### Field

The present disclosure relates generally to earth grounding systems, and more specifically to earth ground enhancing systems that improve DC/AC leakage current dissipation caused by an overvoltage event or occurrence.

### Description of the Related Art

In electrical installations such as electric power distribution stations and substations, and other installations there are structures within such installations that may be susceptible to static charge build-up and that require protection from overvoltage events. Such static charge build-up and overvoltage events may present a safety risk to personnel within such installations. To dissipate charge build-up and overvoltage events, an earth grounding system is typically deployed that connects specific structures of such installations with the Earth's conductive surface for safety purposes and in many instances for functional purposes. For example, electric power distribution systems may require earth grounding systems for safety and functional purposes. Tall structures may have lightning rods as part of a lightning protection system to protect the structures from lightning strikes. Communication towers and antennas may require an earth grounding system for operation, as well as to control static electricity build-up and provide lightning protection.

Typically, such earth grounding systems utilize bare copper conductors buried in the soil that are connected to the structures within the installations. Leakage current on the copper conductors exits the copper conductor and enters the soil to dissipate the leakage current into the earth.

### SUMMARY

The present disclosure provides embodiments of earth ground enhancing systems that improve the dissipation of static direct current electrical energy that may have been imposed on a structure or object being grounded, or that may have built up on a structure or object being grounded. The present disclosure provides embodiments of methods for assembling or installing the earth ground enhancing systems of the present disclosure, and embodiments of methods for grounding structures or objects. The present disclosure also provides embodiments of kits for the distribution of components forming the earth ground enhancing systems contemplated by the present disclosure.

In an exemplary embodiment of an earth ground enhancing system, the system may include one or more conductive mats and one or more conductors. The one or more conductors are secured to the one or more conductive mats so that the positioning of the one or more conductors relative to the one or more conductive mats can remain substantially constant when assembled or installed. The one or more conductive mats may be positioned relative to the one or more conductors by placing the one or more conductive mats on the one or more conductors or by placing the one or more conductors on the one or more conductive mats. In one exemplary embodiment, the one or more conductive mats include a fabric substrate impregnated with a conductive material and a binder that adheres the conductive material to the fabric substrate. The conductive material may be, for example, carbon black. In another exemplary embodiment, the one or more conductive mats may include a fabric substrate impregnated with a conductive material, a moisture retaining material and a binder that adheres the conductive material and moisture retaining material to the fabric substrate. The conductive material may be, for example, carbon black and the moisture retaining material may be, for example, bentonite.

In an exemplary embodiment of a method for assembling or installing an earth ground enhancing system, the method may include positioning one or more conductive mats relative to one or more conductors and attaching the one or more conductive mats to the one or more conductors so that the positioning of the one or more conductors relative to the one or more conductive mats remains substantially constant. The one or more conductive mats may be positioned relative to the one or more conductors by placing the one or more conductive mats on the one or more conductors or by placing the one or more conductors on the one or more conductive mats. In one exemplary embodiment, the one or more conductive mats include a fabric substrate impregnated with a conductive material and a binder that adheres the conductive material to the fabric substrate. The conductive material may be, for example, carbon black. In another exemplary embodiment, the one or more conductive mats may include a fabric substrate impregnated with a conductive material, a moisture retaining material and a binder that adheres the conductive material and moisture retaining material to the fabric substrate. The conductive material may be, for example, carbon black and the moisture retaining material may be, for example, bentonite.

In an exemplary embodiment of a method for grounding a structure or a group of structures, the method may include laying one or more conductors in a trench, electrically connecting the one or more conductors to the structure or structures, laying one or more conductive mats over the one or more conductors, and attaching the one or more conductive mats to the one or more conductors so that the positioning of the one or more conductors relative to the one or more conductive mats remains substantially constant. The method may also include backfilling the trench with soil so that an electrically conductive path is created between at least a portion of each of the one or more conductive mats and at least a portion of each of the one or more conductors. In one exemplary embodiment, the one or more conductive mats include a fabric substrate impregnated with a conductive material and a binder that adheres the conductive material to the fabric substrate. The conductive material may be, for example, carbon black. In another exemplary embodiment, the one or more conductive mats may include a fabric substrate impregnated with a conductive material, a moisture retaining material and a binder that adheres the conductive material and moisture retaining material to the fabric substrate. The conductive material may be, for example, carbon black and the moisture retaining material may be, for example, bentonite.

In an exemplary embodiment of a method for grounding a structure or a group of structures, the method may include laying one or more conductive mats in a trench, laying one or more conductors over the one or more conductive mats, attaching the one or more conductors to the one or more conductive mats so that the positioning of the one or more conductors relative to the one or more conductive mats remains substantially constant, and electrically connecting the one or more conductors to the structure or structures to be grounded. The method may also include backfilling the trench with soil so that an electrically conductive path is created between at least a portion of each of the one or more conductive mats and at least a portion of each of the one or more conductors. In one exemplary embodiment, the one or more conductive mats include a fabric substrate impregnated with a conductive material and a binder that adheres the conductive material to the fabric substrate. The conductive material may be, for example, carbon black. In another exemplary embodiment, the one or more conductive mats may include a fabric substrate impregnated with a conductive material, a moisture retaining material and a binder that adheres the conductive material and moisture retaining material to the fabric substrate. The conductive material may be, for example, carbon black and the moisture retaining material may be, for example, bentonite.

In another exemplary embodiment of an earth ground enhancing system, the system may include a first conductive layer, a second conductive layer and a substrate layer between the first conductive layer and the second conductive layer. The first conductive layer includes one or more conductive mats, and one or more conductors secured to the one or more conductive mats so that the positioning of the one or more conductors relative to the one or more conductive mats can remain substantially constant when assembled or installed. The second conductive layer includes one or more conductive mats, and one or more conductors secured to the one or more conductive mats so that the positioning of the one or more conductors relative to the one or more conductive mats can remain substantially constant when assembled or installed. The substrate layer is positioned between the first conductive layer and the second conductive layer.

In another exemplary embodiment of an earth ground enhancing system, the system may include a first conductive layer, a second conductive layer and a substrate layer between the first conductive layer and the second conductive layer. The first conductive layer includes a first layer conductive mat and a first layer electrical conductor. The first layer electrical conductor is secured to the first layer conductive mat so that the positioning of the first layer conductor relative to the first layer conductive mat remains substantially constant when assembled or installed. The second conductive layer includes a second layer conductive mat and a second layer electrical conductor. The second layer conductor is secured to the second layer conductive mat so that the positioning of the second layer conductor relative to the second layer conductive mat can remain substantially constant when assembled or installed. The substrate layer is positioned between the first conductive layer and the second conductive layer, and may be composed of soil, sand or a combination of soil and sand.

In another exemplary embodiment of a method for grounding a structure or a group of structures, the method may include laying one or more first layer conductors in a trench, electrically connecting the one or more first layer conductors to the structure or structures, laying one or more first layer conductive mats over the one or more first layer conductors, attaching the one or more first layer conductive mats to the one or more first layer conductors so that the positioning of the one or more first layer conductors relative to the one or more first layer conductive mats remains substantially constant. With the first conductive layer formed a substrate layer is formed by filling the trench with a substrate material, such as soil, sand or a combination of soil and sand so that the substrate layer covers the one or more first layer conductive mats. With the substrate layer formed a second conductive layer is formed by laying one or more second layer conductors in the trench on the substrate layer, electrically connecting the one or more second layer conductors to the structure or structures so that the one or more first layer conductors are electrically interconnected with the one or more second layer conductors, laying one or more second layer conductive mats over the one or more second layer conductors, and attaching the one or more second layer conductive mats to the one or more second layer conductors so that the positioning of the one or more second layer conductors relative to the one or more second layer conductive mats remains substantially constant.

### BRIEF DESCRIPTION OF THE DRAWINGS

The figures depict embodiments for purposes of illustration only. One skilled in the art will readily recognize from the following description that alternative embodiments of the structures illustrated herein may be employed without departing from the principles described herein, wherein:

FIG. 1 is a perspective view of a grounding trench with an exemplary embodiment of an earth ground enhancing system according to the present disclosure resting therein, illustrating a grounding conductor resting on soil in the trench and a conductive mat positioned over the grounding conductor and resting on the soil;

FIG. 2 is an enlarged a perspective view of a portion of the grounding trench with the earth ground enhancing system of FIG. 1 taken from detail 2, illustrating a fastener securing the conductor to the conductive mat;

FIG. 3 is a perspective view of a grounding trench with another exemplary embodiment of an earth ground enhancing system according to the present disclosure resting therein, illustrating a conductive mat resting on soil and a grounding conductor resting on the conductive mat;

FIG. 4 is an enlarged a perspective view of a portion of the grounding trench with the earth ground enhancing system of FIG. 3 taken from detail 4, illustrating a fastener securing the conductor to the conductive mat;

FIG. 5 is a perspective view of a portion of the conductive mat of FIG. 1;

FIG. 6 is a perspective view of an exemplary embodiment of a kit for forming the earth ground enhancing system of the present disclosure, illustrating a roll of conductive matting and a coil of ground conductor that when placed in the soil with the conductor is resting either under or over the conductive mat form the earth ground enhancing system of the present disclosure;

FIG. 7 is perspective view of a grounding trench with another exemplary embodiment of an earth ground enhancing system according to the present disclosure resting therein, illustrating a first grounding conductor resting on soil in the trench and a first conductive mat positioned over the grounding conductor and resting on the soil, and a second conductive mat positioned over and resting on the soil and a second grounding conductor resting on the conductive mat;

FIG. 8 is a side elevation view of the grounding trench and earth ground enhancing system of FIG. 7 taken from line 8-8; and

FIG. 9 is a perspective view of a grounding trench with another exemplary embodiment of an earth ground enhancing system according to the present disclosure resting therein, illustrating a conductive mat within the trench and resting on the soil.

### DETAILED DESCRIPTION

The present disclosure provides embodiments of earth ground enhancing systems that improve the dissipation of electrical energy, e.g., static electrical (DC) charges, that may have been imposed on a structure or object being grounded, or that may have built up on a structure or object being grounded. The present disclosure provides embodiments of methods for assembling or installing the earth ground enhancing systems of the present disclosure, and embodiments of methods for grounding structures or objects. The present disclosure also provides embodiments of kits for the distribution of components forming the earth ground enhancing systems contemplated by the present disclosure. The earth ground enhancing systems contemplated by the present disclosure may be used in any environment where electrical energy is to be dissipated through earth ground. For ease of description, the structures and/or objects to be or being grounded may also be referred to herein collectively as the “structure” in the singular and as the “structures” in the plural.

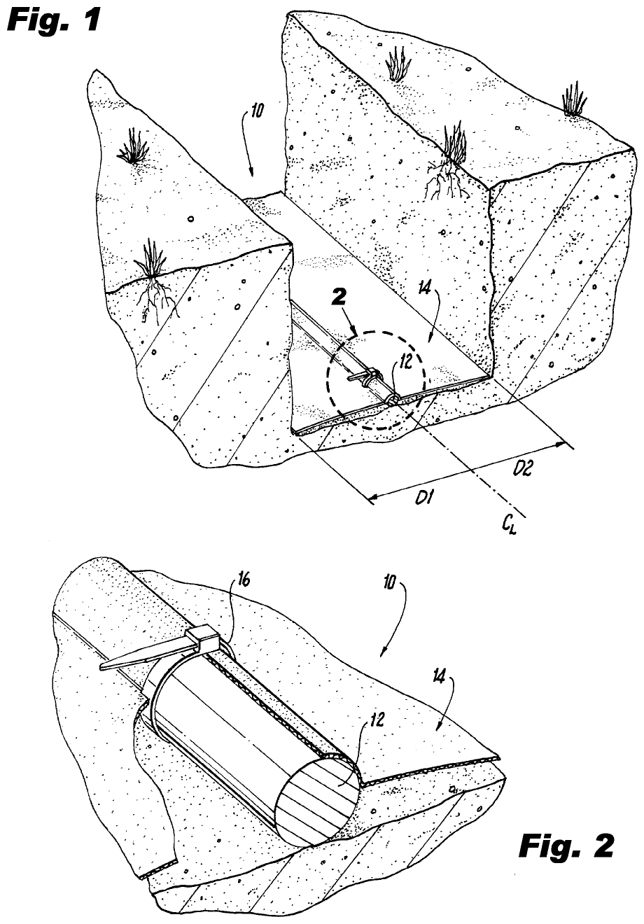

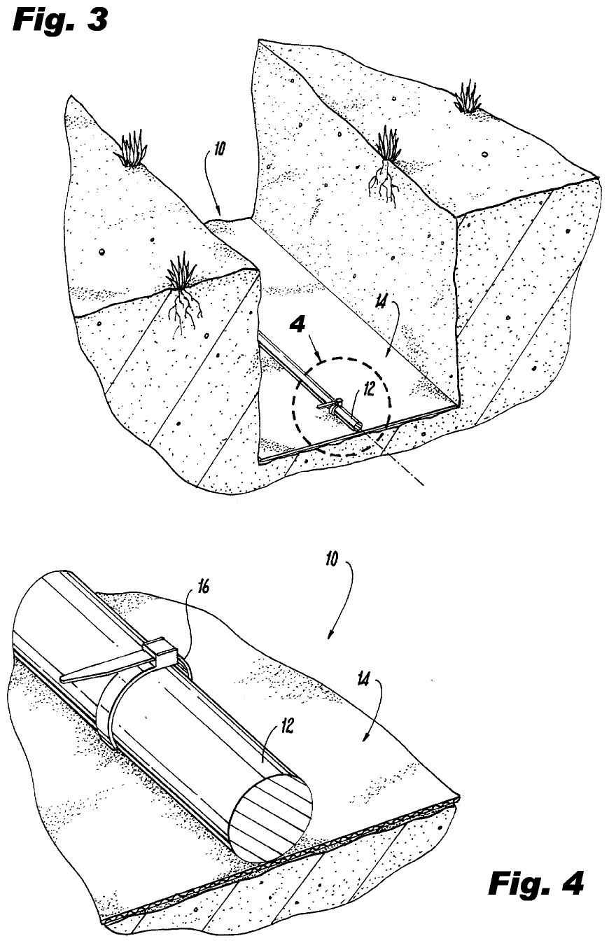

Referring to FIGS. 1-4, the earth ground enhancing system 10 according to the present disclosure includes one or more bare electrical conductors 12 and one or more conductive sheets or mats 14 electrically coupled to the one or more bare electrical conductors 12. In one exemplary embodiment, the earth ground enhancing system 10 is formed by positioning the one or more bare electrical conductors 12 within a trench in the soil and positioning the one or more conductive mats 14 within the trench such that the one or more conductive mats are resting on and in contact with the one or more bare electrical conductors resting on the soil within the trench, as seen in FIGS. 1 and 2. In another exemplary embodiment, the earth ground enhancing system 10 is formed by positioning the one or more conductive mats 14 within a trench in the soil and positioning one or more bare electrical conductors 12 within the trench such that the one or more bare electrical conductors are resting on and in contact with the one or more conductive mats 14 resting on the soil within the trench, as seen in FIGS. 3 and 4. The one or more bare electrical conductors 12 are preferably secured to the one or more conductive mats 14 using one or more fasteners 16 that pass through one or more slots or openings in the conductive mat 14 and around the one or more bare electrical conductors. Non-limiting examples of the fasteners contemplated include string, plastic ties also known as tie-wraps, hook and loop fasteners or any combination thereof. In the exemplary embodiments shown in FIGS. 1-4, the one or more fasteners are plastic ties. The one or more slots may be pre-formed in the conductive mat 14 or made in the conductive mat 14 in the field by an installer. Preferably, the conductor 12 is positioned along a center line “CL” of the conductive mat 14 so that a first distance “D1” from a first side edge of the conductive mat is about the same a second distance “D2” from a second side edge of the conductive mat 14. This ensures that the conductor 12 is positioned in the center of the conductive mat 14. However, the distances D1 and D2 may differ such that the conductor 12 favors one side edge of the conductive mat 14 over the other side edge.

The one or more bare electrical conductors 12 used in the earth ground enhancing system 10 may be referred to as the “conductor” in the singular and the “conductors” in the plural. The one or more conductors 12 may be fabricated of, for example, copper or aluminum, and they may be solid conductors, stranded conductors, braided conductors, or any other type of electrical conductors. The conductor 12 may be any shape conductor. Non-limiting examples include round conductors and flat conductors. The one or more conductors 12 within the trench may have an end or other portion thereof attached to a structure or structures being grounded using, for example, exothermic welds, ground lugs or ground clamps. The length of the one or more conductors 12 may vary depending upon a number of factors, including the structure or structures being grounded and the distance between the structures being grounded. For example, the length of the one or more conductors 12 may range from about 1 foot and greater, e.g., in excess of 1000 feet, to ensure proper leakage current dissipation. More specifically, for every meter of conductive metal of the conductor 12 that is in contact with the soil or stratum, a calculable amount of current flowing through the conductor will exit the conductor and enter the earth. This current that exits the conductor and enters the earth is known as the “leakage current.” The leakage current of the earth ground enhancing systems contemplated by the present disclosure may range from about 0.0001 amps and greater, e.g., in excess of 100,000 amps. The conductors 12 used with the earth ground enhancing systems of the present disclosure range in size from, for example, about 2/0 AWG to about 4/0 AWG. However, the present disclosure contemplates that any size conductor may be included in the earth ground enhancing systems. In the exemplary size range of a about 2/0 AWG to about 4/0 AWG, a ten-foot length conductor would have a dissipation surface area of conductive metal that can contact the soil in the range of about 90 square inches to about 180 square inches. This surface area would permit the leakage current of about 0.0001 amps to about 10000 amps to exit the conductor and enter the soil. The conductive mat used in the earth ground enhancing systems of the present disclosure increases the “leakage current” capacity of the earth ground enhancing systems by increasing the dissipation surface area of the conductor by a factor of at least 10. Thus, in the example above, the dissipation surface area of the conductor 12 plus the conductive mat 14 would be in the range of about 900 square inches to about 1800 square inches.

In one exemplary embodiment, the conductive mats are fabricated from a fabric substrate impregnated with a conductive material and a binder that adheres the conductive material to the fabric substrate. The fabric substrate may be a woven, nonwoven, knit or paper substrate. The fabric substrate may be natural, synthetic or a blend. In the exemplary embodiment of the present disclosure, the fabric substrate is a nonwoven substrate. The fabric substrate is then dipped into an aqueous solution containing a conductive material and a binder so that the fabric substrate is saturated or impregnated with the solution. The saturated fiber substrate is nipped to a predetermined wet add-on, dried and cured to form a flexible, electrically conductive fabric. The aqueous-based treatment is applied using standard textile wet processing methods, and the drying and curing of the saturated fabric are similarly performed by conventional means. The conductive material may be any material capable of providing conductivity to a nonconductive substrate. Examples include carbon black, jet black or lamp black, carbonized acrylonitrile black, dry powdered carbon, tin-doped antimony trioxide, and powdered metal dispersions. The preferred conductive material is carbon black.

The binder used in the aqueous solution can be any binder, resin or latex capable of binding the conductive material to the fabric substrate. Non-limiting examples include, butadiene acrylonitrile latex emulsions, carboxymodified acrylonitrile emulsions, acrylonitrile butadiene styrene emulsions, acrylic emulsions, polyvinyl chloride emulsions, butyl rubber emulsions, ethylene/propylene rubber emulsions, polyurethane emulsions, polyvinyl acetate emulsions, SB vinyl pyridine emulsions, polyvinyl alcohol emulsions, and melamine resins. Blends of these materials, or any aqueous-based emulsions of binders, resins, or latexes, may also be used. A more detailed description of the conductive mat is provided in U.S. Pat. No. 5,723,186 to Fraser, Jr. which is incorporated herein in its entirety by reference.

To ensure sufficient dissipation of leakage current, the surface resistivity of the conductive mat 14 is in the range of about 1×10⁻⁴ ohm per square foot and about 1.0×10¹⁰ ohms per square foot. It is noted that the greater the surface resistivity of the conductive mat 14 the more DC/AC current the conductive mat 14 may dissipate. As a result, the surface resistivity of the conductive mat 14 can be adjusted by, for example, including known additives to the aqueous solution to adjust the ratio of the fabric substrate to the conductive material.

To further improve the dissipation of leakage current from the conductive mat 14 a moisture retaining material may be added to the aqueous solution containing the conductive material and binder so that the fiber substrate is saturated or impregnated with a solution of conductive material, binder and moisture retaining material. A non-limiting example of a suitable moisture retaining material includes bentonite, which is a moisture retaining clay that can help to lower the resistivity between the conductive mat 14 and the soil. The conductive bentonite clay is a sodium activated montmorillonite which when mixed with water swells to several times its original volume mass when in a dry condition. The inherent ability of bentonite to absorb and retain water increases the electrical conductivity between the conductive mat 14 and the soil. Typically, bentonite has a 3 ohms per meter resistivity level.

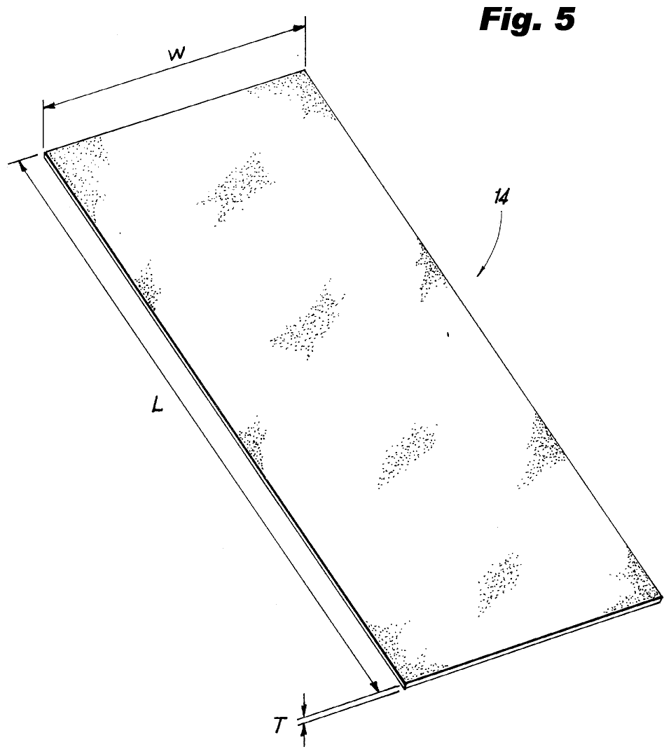

The conductive mat 14 may vary in length “L”, width “W” and thickness “T”, seen in FIG. 5, depending upon, for example, the size of the conductor 12, the length of the conductor, the length of the trench, the type of soil, and the anticipated leakage current. As a non-limiting example, if the conductor is a 2/0 AWG conductor, the length of the conductor is 1.0 meter and the anticipated leakage current is greater than or equal to 20 amps, the length “L” of the conductive mat 14 would be about 20 feet, the width “W” of the conductive mat 14 would be about 1 foot, and the thickness “T” of the conductive mat 14 would be about 0.0625 inches.

As set forth above, the present disclosure provides embodiments of methods for assembling or installing the earth ground enhancing systems of the present disclosure. In an exemplary embodiment, and referring again to FIGS. 1 and 2, a method for assembling an earth ground enhancing system may include positioning one or more conductive mats 14 onto one or more conductors 12 resting in a trench and attaching the one or more conductive mats 14 to the one or more conductors 12 using, for example, the plastic ties 16. As noted above, the one or more conductors 12 are attached to the one or more conductive mats 14 so that the positioning of the one or more conductors 12 relative to the one or more conductive mats 14 remains substantially constant. In one implementation of this exemplary method, the conductive mat 14 may be the conductive mat 14 described above having the fiber substrate, the conductive material, e.g., the carbon black material, and the binder. In another implementation of this exemplary method, the conductive mat 14 may be the conductive mat 14 described above having the fiber substrate, the conductive material, e.g., the carbon black material, the binder and the moisture retaining material, e.g., the bentonite material.

In another exemplary embodiment, and referring again to FIGS. 3 and 4, a method for assembling an earth ground enhancing system may include positioning one or more conductors 12 onto one or more conductive mats 14 resting in a trench and attaching the one or more conductive mats 14 to the one or more conductors 12 using, for example, the plastic ties 16. As noted above, the one or more conductors 12 are attached to the one or more conductive mats 14 so that the positioning of the one or more conductors 12 relative to the one or more conductive mats 14 remains substantially constant. In one implementation of this exemplary method, the conductive mats 14 may be the conductive mat 14 described above having the fiber substrate, the conductive material, e.g., the carbon black material, and the binder. In another implementation of this exemplary method, the conductive mats 14 may be the conductive mat 14 described above having the fiber substrate, the conductive material, e.g., the carbon black material, the binder and the moisture retaining material, e.g., the bentonite material.

As set forth above, the present disclosure provides embodiments of methods for grounding structures. In an exemplary embodiment, and referring again to FIGS. 1 and 2, a method for grounding structures may include laying one or more conductors 12 in a trench, electrically connecting the one or more conductors 12 to a structure or structures to be grounded by connecting at least one end of each conductor 12 to a designated earth ground structure or conductor on the structure or structures, laying one or more conductive mats 14 over the one or more conductors 12, and attaching the one or more conductive mats 14 to the one or more conductors 12 using, for example, the plastic ties 16. As noted above, the one or more conductors 12 are attached to the one or more conductive mats 14 so that the positioning of the one or more conductors 12 relative to the one or more conductive mats 14 remains substantially constant. The trench may then be backfilled with soil to ensure that an electrically conductive path is created between at least a portion of each of the one or more conductive mats 14 and at least a portion of each of the one or more conductors 12. In one implementation of this exemplary method, the one or more conductive mats 14 may be the conductive mat 14 described above having the fiber substrate, the conductive material, e.g., the carbon black material, and the binder. In another implementation of this exemplary method, the one or more conductive mats 14 may be the conductive mat 14 described above having the fiber substrate, the conductive material, e.g., the carbon black material, the binder and the moisture retaining material, e.g., the bentonite material.

In another exemplary embodiment, and referring again to FIGS. 3 and 4, a method for grounding a structure or structures may include laying one or more conductive mats 14 in a trench, laying one or more conductors 12 over the one or more conductive mats 14, attaching the one or more conductors 12 to the one or more conductive mats 14 using, for example, the plastic ties 16. As noted above, the one or more conductors 12 are attached to the one or more conductive mats 14 so that the positioning of the one or more conductors 12 relative to the one or more conductive mats 14 remains substantially constant, and electrically connecting the one or more conductors 12 to the structure or structures to be grounded by connecting at least one end of each conductor 12 to a designated earth ground structure or conductor on the structure or structures. The trench may then be backfilled with soil to ensure that an electrically conductive path is created between at least a portion of each of the one or more conductive mats 14 and at least a portion of each of the one or more conductors 12. In one implementation of this exemplary method, the one or more conductive mats 14 may be the conductive mat described above having the fiber substrate, the conductive material, e.g., the carbon black material, and the binder. In another implementation of this exemplary method, the one or more conductive mats 14 may be the conductive mat described above having the fiber substrate, the conductive material, e.g., the carbon black material, the binder and the moisture retaining material, e.g., the bentonite material.

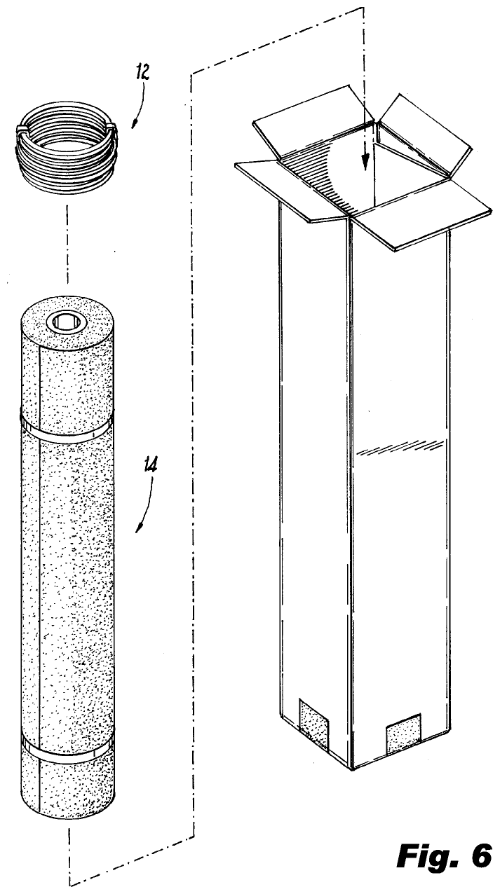

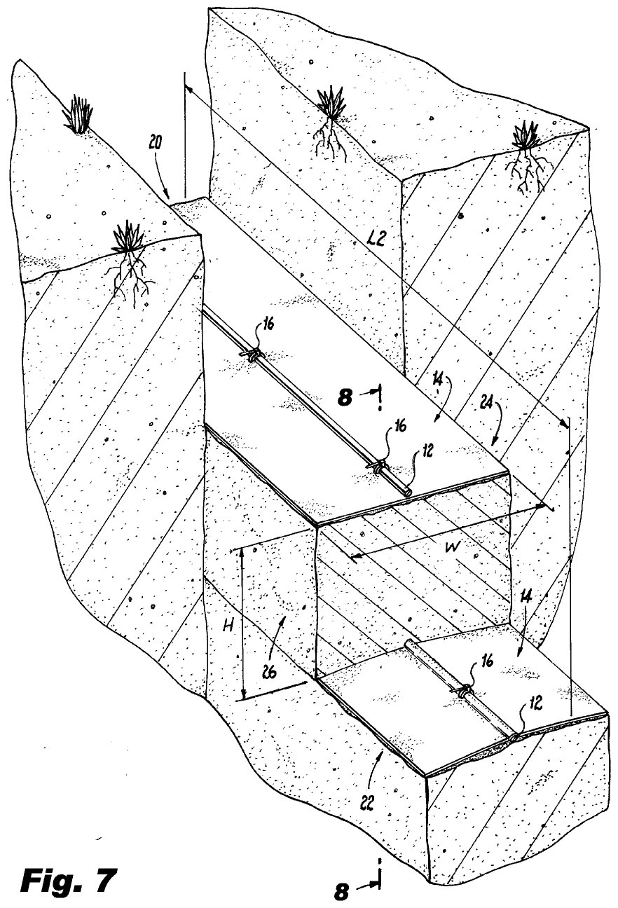

Referring to FIG. 6, as set forth above the present disclosure provides embodiments of kits for the distribution of components forming the earth ground enhancing systems contemplated by the present disclosure. In the exemplary embodiment of FIG. 6, the kit includes one or more coils of a conductor 12 and one or more rolls of a conductive mat 14. The kit may also include one or more fasteners 16 that can be passed through the slots or openings in the conductive mat 14 and around the conductor 12 so that the conductor 12 is secured to the conductive mat 14 and so that the positioning of the conductor 12 relative to the conductive mat 14 can remain substantially constant when assembled or installed. Non-limiting examples of the fasteners contemplated by the present disclosure include string, plastic ties also known as tie-wraps, and hook and loop fasteners. The coil of conductor 12 may be, for example, a solid conductor, a stranded conductor, a braided conductor or any other type of electrical conductor. The coil of conductor may be a coil of copper or aluminum conductor. In an exemplary embodiment of the kit, the roll of conductive mat 14 may be the conductive mat described above having the fiber substrate, the conductive material, e.g., the carbon black material, and the binder. In another exemplary embodiment of the kit, the one or more conductive mats 14 may be the conductive mat described above having the fiber substrate, the conductive material, e.g., the carbon black material, the binder and the moisture retaining material, e.g., the bentonite material.

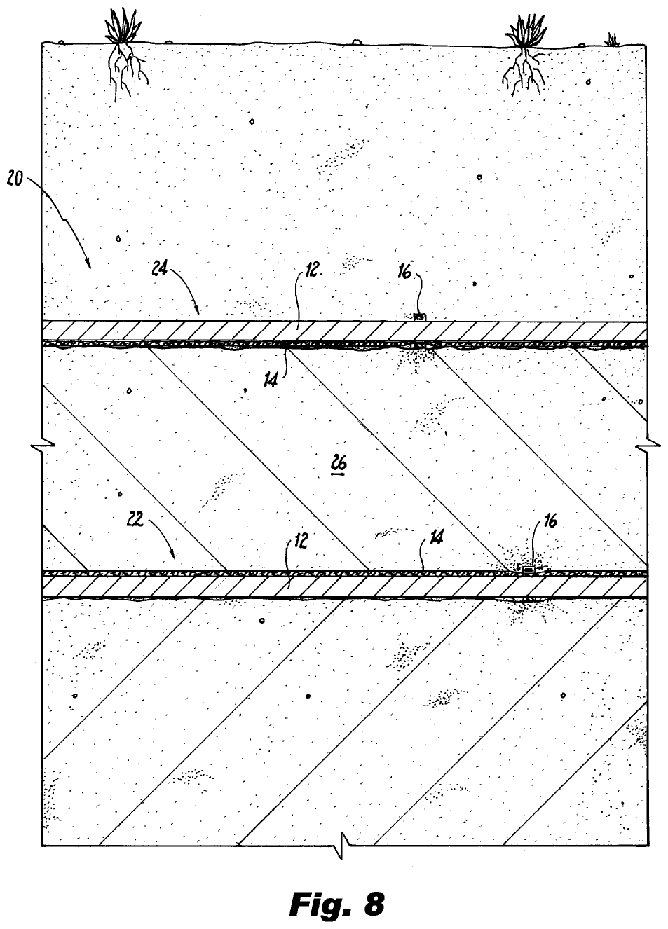

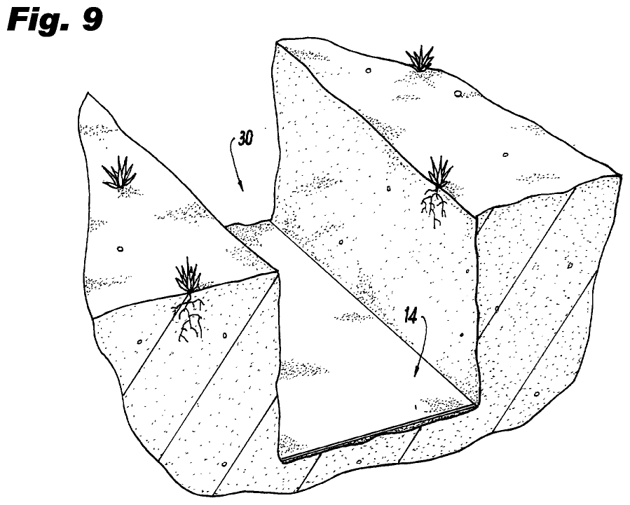

Referring now to FIGS. 7 and 8, another exemplary embodiment of an earth ground enhancing system according to the present disclosure is shown. In this exemplary embodiment, the earth ground enhancing system 20 includes a first conductive layer 22 and a second conductive layer 24 separated by a substrate layer 26. An exemplary embodiment of the first conductive layer 22 includes one or more bare electrical conductors 12 and one or more conductive sheets or mats 14 electrically coupled to the one or more bare electrical conductors 12. In the exemplary embodiment shown, the first conductive layer 22 is formed by positioning the one or more bare electrical conductors 12 within a trench in the soil and positioning the one or more conductive mats 14 within the trench such that the one or more conductive mats are resting on and in contact with the one or more bare electrical conductors resting on the soil within the trench, similar to that shown in FIGS. 1 and 2. In another exemplary embodiment, the first conductive layer 22 may be formed by positioning the one or more conductive mats 14 within a trench in the soil and positioning one or more bare electrical conductors 12 within the trench such that the one or more bare electrical conductors are resting on and in contact with the one or more conductive mats 14 resting on the soil within the trench, similar to that shown in FIGS. 3 and 4. In both embodiments described above, the one or more bare electrical conductors 12 are preferably secured to the one or more conductive mats 14 using one or more fasteners 16 that pass through one or more slots or openings in the conductive mat 14 and around the one or more bare electrical conductors. Non-limiting examples of the fasteners contemplated include string, plastic ties also known as tie-wraps, hook and loop fasteners or any combination thereof. In the exemplary embodiments shown, the one or more fasteners 16 are plastic ties.

Continuing to refer to FIGS. 7 and 8, the second conductive layer 24 is formed by positioning the one or more conductive mats 14 within a trench in the soil and positioning one or more bare electrical conductors 12 within the trench such that the one or more bare electrical conductors are resting on and in contact with the one or more conductive mats 14 resting on the soil within the trench, similar to that shown in FIGS. 3 and 4. In another exemplary embodiment, the second conductive layer 24 may be formed by positioning the one or more bare electrical conductors 12 within a trench in the soil and positioning the one or more conductive mats 14 within the trench such that the one or more conductive mats are resting on and in contact with the one or more bare electrical conductors resting on the soil within the trench, similar to that shown in FIGS. 1 and 2. In both embodiments described above, the one or more bare electrical conductors 12 are preferably secured to the one or more conductive mats 14 using one or more fasteners 16 that pass through one or more slots or openings in the conductive mat 14 and around the one or more bare electrical conductors. Non-limiting examples of the fasteners contemplated include string, plastic ties also known as tie-wraps, hook and loop fasteners or any combination thereof. In the exemplary embodiments shown, the one or more fasteners 16 are plastic ties.

As described above, preferably the conductor 12 is positioned along a center line “CL,” seen in FIG. 1, of the conductive mat 14 so that a first distance “D1” from a first side edge of the conductive mat is about the same a second distance “D2” from a second side edge of the conductive mat 14. This ensures that the conductor 12 is positioned in the center of the conductive mat 14. However, the distances D1 and D2 may differ such that the conductor 12 favors one side edge of the conductive mat 14 over the other side edge.

As described above, in one exemplary embodiment, the conductive mats are fabricated from a fabric substrate impregnated with a conductive material and a binder that adheres the conductive material to the fabric substrate. The fabric substrate may be a woven, nonwoven, knit or paper substrate. The fabric substrate may be natural, synthetic or a blend. In the exemplary embodiment of the present disclosure, the fabric substrate is a nonwoven substrate. The fabric substrate is then dipped into an aqueous solution containing a conductive material and a binder so that the fabric substrate is saturated or impregnated with the solution. The saturated fiber substrate is nipped to a predetermined wet add-on, dried and cured to form a flexible, electrically conductive fabric. The aqueous-based treatment is applied using standard textile wet processing methods, and the drying and curing of the saturated fabric are similarly performed by conventional means. The conductive material may be any material capable of providing conductivity to a nonconductive substrate. Examples include carbon black, jet black or lamp black, carbonized acrylonitrile black, dry powdered carbon, tin-doped antimony trioxide, and powdered metal dispersions. The preferred conductive material is carbon black. A more detailed description of the conductive mats 14 is provided above and is not repeated.

Continuing to refer to FIGS. 7 and 8, the substrate layer 26 is positioned between the first conductive layer 22 and the second conductive layer 24. The substrate layer 26 has a length “L2” that is substantially the same length “L” of the mat 14 of the first conductive layer 22 which is described above and for ease of description is not repeated. The substrate layer 26 has a width “W2” that is substantially the same width “W” as the mat 14 of the first conductive layer 22 which is described above and for ease of description is not repeated. The substrate layer 26 has a height “H” that is suitable to store static electrical (DC) charge. As a non-limiting example, the height “H” of the substrate may be about four inches or greater. The substrate layer 26 is preferably composed of a material that is less conductive than the mats 14 on the two conductive layers 22 and 24. In other words, the substrate layer 26 is preferably composed of a material that has a higher resistance that the mats 14 in the two conductive layers 22 and 24. Non-limiting examples of a suitable substrate material include soil, sand or a combination of soil and sand. As seen in FIG. 8, the first conductive layer 22, the second conductive layer 24 and the substrate layer 26 form a capacitive type charge storage system where the first and second conductive layers 22 and 24 form the plates and the substrate layer 26 forms the dielectric between the layers 22 and 24 that stores the static electrical (DC/AC) charge from, for example, an overvoltage event, such as a lightning strike and other overvoltage events. The charge stored in the substrate layer 26 is then dissipated over time through the mats 14, the substrate material 14 and the conductors 12 to earth ground.

Referring again to FIGS. 7 and 8, another exemplary embodiment of a method for grounding a structure or structures is provided. In this exemplary embodiment, to form the first conductive layer 22, one or more conductors 12 are first laid in a trench. The one or more conductors 12 are electrically connected to a structure or structures to be grounded by connecting at least one end of each conductor 12 to a designated earth ground connector or conductor on the structure or structures. One or more conductive mats 14 are laid over the one or more conductors 12, and the one or more conductive mats 14 are attached to the one or more conductors 12 using, for example, the plastic ties 16 to form the first conductive layer 22. As noted above, the one or more conductors 12 are attached to the one or more conductive mats 14 so that the positioning of the one or more conductors 12 relative to the one or more conductive mats 14 remains substantially constant. The trench may then be backfilled with the substrate material, e.g., soil, sand or a combination of soil and sand, to form the substrate layer 26 and to ensure that an electrically conductive path is created between at least a portion of each of the one or more conductive mats 14 and at least a portion of each of the one or more conductors 12 of the first conductive layer 22. In one implementation of this exemplary method, the one or more conductive mats 14 of the first conductive layer 22 may be the conductive mat 14 described above having the fiber substrate, the conductive material, e.g., the carbon black material, and the binder. In another implementation of this exemplary method, the one or more conductive mats 14 of the first conductive layer 22 may be the conductive mat 14 described above having the fiber substrate, the conductive material, e.g., the carbon black material, the binder and the moisture retaining material, e.g., the bentonite material.

Continuing to refer to FIGS. 7 and 8, to form the second conductive layer 24, one or more conductive mats 14 are placed in the trench on the substrate layer 26. One or more conductors 12 are then placed on the one or more conductive mats 14, and the one or more conductors 12 are attached to the one or more conductive mats 14 using, for example, the plastic ties 16. As noted above, the one or more conductors 12 are attached to the one or more conductive mats 14 so that the positioning of the one or more conductors 12 relative to the one or more conductive mats 14 remains substantially constant. With the second conductive layer 24 formed, the one or more conductors 12 of the second conductive layer 24 are electrically connected to the structure or structures to be grounded by connecting at least one end of each conductor 12 to a designated earth ground connection or conductor on the structure or structures. It is noted that the one or more conductors 12 of the second conductive layer 24 are preferably electrically interconnected with the one or more conductors 12 of the first conductive layer 22 so that the one or more conductors 12 of the first conductive layer 22 and the one or more conductors 12 of the second conductive layer 24 have the same voltage. The trench may then be backfilled with soil to ensure that an electrically conductive path is created between at least a portion of each of the one or more conductive mats 14 and at least a portion of each of the one or more conductors 12. In one implementation of this exemplary method, the one or more conductive mats 14 of the second conductive layer 24 may be the conductive mat described above having the fiber substrate, the conductive material, e.g., the carbon black material, and the binder. In another implementation of this exemplary method, the one or more conductive mats 14 of the second conductive layer 24 may be the conductive mat described above having the fiber substrate, the conductive material, e.g., the carbon black material, the binder and the moisture retaining material, e.g., the bentonite material.

Referring now to FIG. 9, another exemplary embodiment of an earth ground enhancing system is provided. The earth ground enhancing system 30 includes one or more conductive sheets or mats 14 buried in the soil and spaced apart. The earth ground enhancing system 30 is formed by positioning the one or more conductive mats 14 within a trench in the soil. In this exemplary embodiment, the buried conductive mats 14 would act as a reservoir to attract and store static electrical (DC/AC) charge in the soil within a predefined area of the mats 14 that will be later dissipated over time though the soil. This predefined area is dependent upon a number of factors, including the composition of the soil, the length of the mat 14, the width of the mat 14 and the thickness of the mat 14. As a non-limiting example, for dissipating 20 amps or greater, predefined area may be about 3 feet by about 9 feet by about 2 feet.

As described above, in one exemplary embodiment, the conductive mats are fabricated from a fabric substrate impregnated with a conductive material and a binder that adheres the conductive material to the fabric substrate. The fabric substrate may be a woven, nonwoven, knit or paper substrate. The fabric substrate may be natural, synthetic or a blend. In the exemplary embodiment of the present disclosure, the fabric substrate is a nonwoven substrate. The fabric substrate is then dipped into an aqueous solution containing a conductive material and a binder so that the fabric substrate is saturated or impregnated with the solution. The saturated fiber substrate is nipped to a predetermined wet add-on, dried and cured to form a flexible, electrically conductive fabric. The aqueous-based treatment is applied using standard textile wet processing methods, and the drying and curing of the saturated fabric are similarly performed by conventional means. The conductive material may be any material capable of providing conductivity to a nonconductive substrate. Examples include carbon black, jet black or lamp black, carbonized acrylonitrile black, dry powdered carbon, tin-doped antimony trioxide, and powdered metal dispersions. The preferred conductive material is carbon black.

The binder used in the aqueous solution can be any binder, resin or latex capable of binding the conductive material to the fabric substrate. Non-limiting examples include, butadiene acrylonitrile latex emulsions, carboxymodified acrylonitrile emulsions, acrylonitrile butadiene styrene emulsions, acrylic emulsions, polyvinyl chloride emulsions, butyl rubber emulsions, ethylene/propylene rubber emulsions, polyurethane emulsions, polyvinyl acetate emulsions, SB vinyl pyridine emulsions, polyvinyl alcohol emulsions, and melamine resins. Blends of these materials, or any aqueous-based emulsions of binders, resins, or latexes, may also be used. A more detailed description of the conductive mat is provided in U.S. Pat. No. 5,723,186 to Fraser, Jr.

To ensure sufficient dissipation of leakage current, the surface resistivity of the conductive mat 14 is in the range of about 1×10⁻⁴ ohm per square foot and about 1.0×10¹⁰ ohms per square foot. It is noted that the greater the surface resistivity of the conductive mat 14 the more DC/AC current the conductive mat 14 may dissipate. As a result, the surface resistivity of the conductive mat 14 can be adjusted by, for example, including known additives to the aqueous solution to adjust the ratio of the fabric substrate to the conductive material.

To further improve the dissipation of leakage current from the conductive mat 14 a moisture retaining material may be added to the aqueous solution containing the conductive material and binder so that the fiber substrate is saturated or impregnated with a solution of conductive material, binder and moisture retaining material. A non-limiting example of a suitable moisture retaining material includes bentonite, which is a moisture retaining clay that can help to lower the resistivity between the conductive mat 14 and the soil. The conductive bentonite clay is a sodium activated montmorillonite which when mixed with water swells to several times its original volume mass when in a dry condition. The inherent ability of bentonite to absorb and retain water increases the electrical conductivity between the conductive mat 14 and the soil. Typically, bentonite has a 3 ohms per meter resistivity level.

The conductive mat 14 may vary in length “L”, width “W” and thickness “T”, seen in FIG. 5, depending upon, for example, the type of soil, the length of the trench and the anticipated leakage current. As a non-limiting example, if the trench is about 20 feet in length and the anticipated leakage current is greater than or equal to 20 amps, the length “L” of the conductive mat 14 would be about 20 feet, the width “W” of the conductive mat 14 would be about 1 foot, and the thickness “T” of the conductive mat 14 would be about 0.0625 inches.

As set forth above, the present disclosure also provides embodiments of methods for assembling or installing the earth ground enhancing system of FIG. 9. In an exemplary embodiment a method for assembling the earth ground enhancing system of FIG. 9 includes positioning one or more conductive mats 14 in a trench so that the one or more conductive mats 14 are resting on the soil. In one implementation of this exemplary method, the conductive mat 14 may be the conductive mat 14 described above having the fiber substrate, the conductive material, e.g., the carbon black material, and the binder. In another implementation of this exemplary method, the conductive mat 14 may be the conductive mat 14 described above having the fiber substrate, the conductive material, e.g., the carbon black material, the binder and the moisture retaining material, e.g., the bentonite material.

While exemplary embodiments of the present disclosure have been described above and illustrated herein, it should be understood that these are exemplary of the disclosure and are not to be considered as limiting. Additions, deletions, substitutions, and other modifications can be made without departing from the spirit or scope of the present disclosure. Accordingly, the present disclosure is not to be considered as limited by the foregoing description.

What is claimed is:

1. An earth ground enhancing system comprising:
a first conductive layer including:
one or more conductive mats; and
one or more conductors secured to the one or more conductive mats so that the positioning of the one or more conductors relative to the one or more conductive mats can remain substantially constant when assembled or installed;
a second conductive layer including:
one or more conductive mats; and
one or more conductors secured to the one or more conductive mats so that the positioning of the one or more conductors relative to the one or more conductive mats can remain substantially constant when assembled or installed; and
a substrate layer between the first conductive layer and the second conductive layer.

2. The system according to claim 1, wherein each of the one or more conductive mats in the first conductive layer comprise a fabric substrate impregnated with a conductive material and a binder that adheres the conductive material to the fabric substrate.

3. The system according to claim 2, wherein the conductive material comprises carbon black.

4. The system according to claim 1, wherein each of the one or more conductive mats in the first conductive layer comprise a fabric substrate impregnated with a conductive material, a moisture retaining material and a binder that adheres the conductive material and moisture retaining material to the fabric substrate.

5. The system according to claim 4, wherein the conductive material comprises carbon black and the moisture retaining material comprises bentonite.

6. The system according to claim 1, wherein each of the one or more conductive mats in the second conductive layer comprise a fabric substrate impregnated with a conductive material and a binder that adheres the conductive material to the fabric substrate.

7. The system according to claim 6, wherein the conductive material comprises carbon black.

8. The system according to claim 1, wherein each of the one or more conductive mats in the second conductive layer comprise a fabric substrate impregnated with a conductive material, a moisture retaining material and a binder that adheres the conductive material and moisture retaining material to the fabric substrate.

9. The system according to claim 8, wherein the conductive material comprises carbon black and the moisture retaining material comprises bentonite.

10. The system according to claim 1, wherein the substrate layer comprises a material that is less conductive than the conductive mats in the first conductive layer and the second conductive layer.

11. The system according to claim 1, wherein the substrate layer comprises soil, sand or a combination of soil and sand.

12. A method for grounding a structure or a group of structures comprising:
laying one or more first layer conductors in a trench;
electrically connecting the one or more first layer conductors to the structure or structures;
laying one or more first layer conductive mats over the one or more first layer conductors;
attaching the one or more first layer conductive mats to the one or more first layer conductors so that the positioning of the one or more first layer conductors relative to the one or more first layer conductive mats remains substantially constant;
filling the trench with a substrate layer so that the substrate layer covers the one or more first layer conductive mats;
laying one or more second layer conductors in the trench;
electrically connecting the one or more second layer conductors to the structure or structures so that the one or more first layer conductors are electrically interconnected with the one or more second layer conductors;
laying one or more second layer conductive mats over the one or more second layer conductors; and
attaching the one or more second layer conductive mats to the one or more second layer conductors so that the positioning of the one or more second layer conductors relative to the one or more second layer conductive mats remains substantially constant.

13. The method according to claim 12, further comprising backfilling the trench with soil to ensure that an electrically conductive path is created between at least a portion of each of the one or more second layer conductive mats and at least a portion of each of the one or more second layer conductors.

14. The system according to claim 12, wherein each of the one or more first layer and second layer conductive mats comprise a fabric substrate impregnated with a conductive material and a binder that adheres the conductive material to the fabric substrate.

15. The system according to claim 14, wherein the conductive material comprises carbon black.

16. The system according to claim 12, wherein each of the one or more first layer and second layer conductive mats comprise a fabric substrate impregnated with a conductive material, a moisture retaining material and a binder that adheres the conductive material and moisture retaining material to the fabric substrate.

17. The system according to claim 16, wherein the conductive material comprises carbon black and the moisture retaining material comprises bentonite.

18. The system according to claim 12, wherein the substrate layer comprises soil, sand or a combination of soil and sand.

19. An earth ground enhancing system comprising:
a first conductive layer including:
a first layer conductive mat; and
a first layer electrical conductor secured to the first layer conductive mat so that the positioning of the first layer conductor relative to the first layer conductive mat can remain substantially constant when assembled or installed;
a second conductive layer including:
a second layer conductive mat; and
a second layer conductor secured to the second layer conductive mat so that the positioning of the second layer conductor relative to the second layer conductive mat can remain substantially constant when assembled or installed; and
a substrate layer between the first conductive layer and the second conductive layer.

20. The system according to claim 19, wherein the first and second layer conductive mats comprise a fabric substrate impregnated with a conductive material and a binder that adheres the conductive material to the fabric substrate.

21. The system according to claim 20, wherein the conductive material comprises carbon black.

22. The system according to claim 19, wherein the first and second layer conductive mats in comprise a fabric substrate impregnated with a conductive material, a moisture retaining material and a binder that adheres the conductive material and moisture retaining material to the fabric substrate.

23. The system according to claim 22, wherein the conductive material comprises carbon black and the moisture retaining material comprises bentonite.

24. The system according to claim 19, wherein the substrate layer comprises soil, sand or a combination of soil and sand.
